(19) United States
(12) Patent Application Publication
(10) Pub. No.: US 2016/0225282 A1
(43) Pub. Date: Aug. 4, 2016

(54) INDIVIDUALIZED NEEDS EVALUATION AND EXPERTISE DEVELOPMENT SYSTEM FOR ELECTRONIC MEDICAL RECORD USERS

(71) Applicant: Mayo Foundation for Medical Education and Research, Rochester, MN (US)

(72) Inventor: Joel E. Gordon, North Mankato, MN (US)

(21) Appl. No.: 15/026,899

(22) PCT Filed: Oct. 2, 2014
(86) PCT No.: PCT/US2014/058780

§ 371 Date: Apr. 1, 2016

Related U.S. Application Data
(60) Provisional application No. 61/886,219, filed on Oct. 3, 2013.

(51) Int. Cl. G09B 19/00; G09B 5/00

(52) U.S. Cl. CPC G09B 19/0053; G09B 5/00

(57) ABSTRACT

A computer system and method to assess a user's ability to use an electronic medical record (EMR) system. Clinical assessment scenarios and prompts for the user's responses to the scenarios are presented on a user interface. The scenarios simulate a work day and each scenario has multiple EMR workflows. Scenario background questions relating to the clinical assessment scenarios, and prompts for the user's responses, are presented on the user interface. The scenario background questions assess one or more of how frequently the user performs the scenario and the value of the scenario to the user's practice. The user's responses to the clinical assessment scenarios and the scenario background questions are evaluated. A quantitative assessment of need for the clinical assessment scenarios based on the evaluated clinical assessment scenario responses and the scenario background question responses is generated.

### FIELD OF THE INVENTION

The invention relates generally to computer-based systems for training users on electronic medical record (EMR) systems.

### BACKGROUND

User satisfaction with electronic medical record (EMR) systems can be low. Some observational studies suggest that this lack of satisfaction may be tied to a low level of proficiency with the available functionality. These observations also seem to imply that decreased proficiency is the result of many variables, not just knowledge base alone. Moreover, poor provider adoption and proficiency can bring into question patient safety due to a “garbage in-garbage out” phenomenon; i.e. individualized work-a-rounds, hybrid paper and electronic charting practices, etc., and a movement away from standardized practices that are generally desirable. These inconsistencies put the accuracy and usefulness of EMR at risk, thus compromising patient safety.

There is relatively little standardization for how providers are taught to use the EMR, and no measurement tool to measure proficiency of use or improvement thereof. For example, when providers are assimilated into a practice, they might receive 4-6 hours of classroom training, a relatively limited amount. An individualized recheck at 6-12 weeks after starting a clinical practice may be offered; however, this may not be standardized, and may not always be scheduled. Nor is it presented as a practice quality initiative, but rather as an EMR navigational discussion. For these and other reasons, informaticists may see only 20-25% of providers exercising this opportunity. Also noteworthy is that limited if any data metrics are gathered during the training process. Nor is substantial validation occurring about a provider's understanding or proficiency. This lack of validation may jeopardize the integrity of the data providers depend on, as well as the patient safety they value. There remains, therefore, a continuing need for improved tools to enhance, measure and verify provider's proficiency with EMR.

### SUMMARY

Embodiments of the invention include a method for operating a computer system to assess a user's ability to use an electronic medical record (EMR) system. Embodiments include: (1) presenting, on a user interface, clinical assessment scenarios and prompting the user's responses to the scenarios, wherein the scenarios simulate a work day and each scenario has multiple EMR workflows, (2) receiving through the user interface and evaluating the user's responses to the clinical assessment scenarios, wherein evaluating the responses includes one or more of determining a length of time to complete the scenario, counting keystrokes/clicks to complete the scenario and recording the screens viewed during the scenario, (3) presenting, on a user interface, scenario background questions relating to the clinical assessment scenarios, and prompting the user's responses to the scenario background questions, wherein the scenario background questions assess one or more of how frequently the user performs the scenario and the value of the scenario to the user's practice, (4) receiving through the user interface and evaluating the user's responses to the scenario background questions, and (5) generating a quantitative assessment of need for the clinical assessment scenarios based on the evaluated clinical assessment scenario responses and the scenario background question responses.

In other embodiments, generating the quantitative assessments of need for the clinical assessment scenarios further includes generating the quantitative assessments based on values of the scenarios to an organization to which the user belongs. In yet other embodiments, evaluating the user's responses to the clinical assessment scenarios can include generating a quantitative assessment representative of the user's inefficiency, and generating the quantitative assessments of need for the clinical assessment scenarios can include generating the quantitative assessments of need based on the quantitative assessment of the user's inefficiency. In still other embodiments, generating the quantitative assessments of need includes generating the quantitative assessments based on both of how frequently the user performs the scenario and the value of the scenario to the user's practice.

### BRIEF DESCRIPTION OF THE DRAWINGS

FIG. 1 is a diagrammatic illustration of a computer system that can be used to implement embodiments of the invention.

FIG. 2 is a flow diagram illustrating steps of a needs assessment in accordance with embodiments of the invention.

### DESCRIPTION OF THE INVENTION

Embodiments of the invention are automated, computer-based tools to measure, verify and/or enhance provider proficiency with electronic medical record (EMR) systems. The tool provides quantified individualized needs evaluation and expertise development, as well as insight into EMR use, training and build. Efficiency, safety and personalized training can be optimized by use of the system and method.

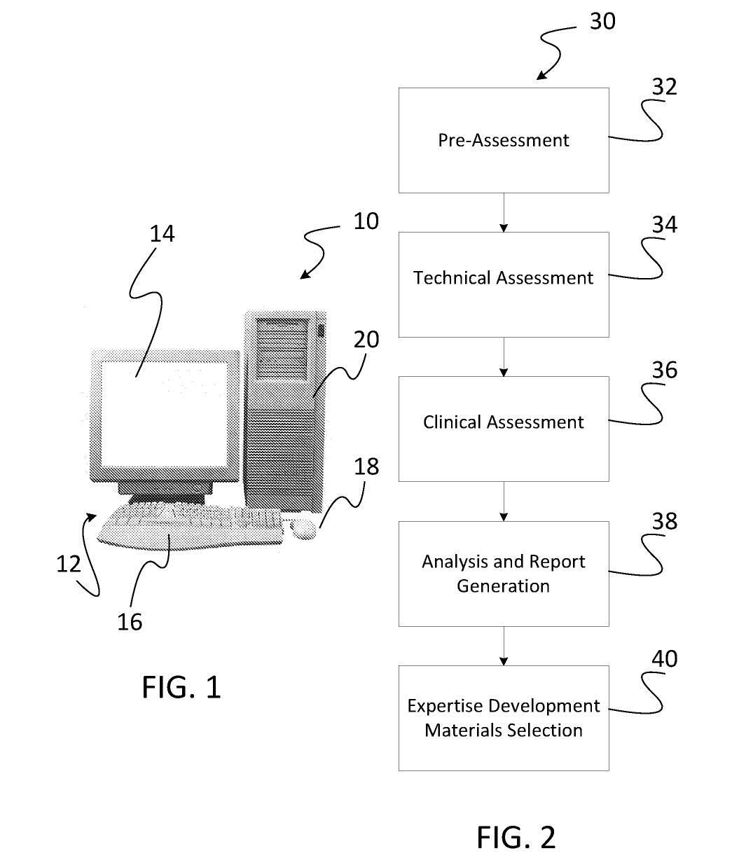

FIG. 1 is a diagrammatic illustration of a computer system 10 that can be used to implement embodiments of the needs assessment method. As shown, computer system 10 includes a graphical user interface 12 having a monitor 14, keyboard 16 and mouse 18. A processing system 20 that has a memory or database (not separately shown) is coupled to the user interface 12. The illustrated embodiment of computer system 10 is shown for purposes of example, and other embodiments of the invention have different or additional components, such as other user interfaces for administrators and providers that use the system, and different or additional memory and database structures.

FIG. 2 is a flow diagram illustrating steps of a needs assessment and expertise development method 30 in accordance with embodiments of the invention. As shown, method 30 includes a pre-assessment 32, technical assessment 34, clinical assessment 36, analysis and report generation 38 and expertise development materials selection 40. Although illustrated in one particular order, the steps of method 30 can be performed in other orders. Furthermore, some embodiments of the invention do not include all the illustrated steps.

During pre-assessment 32, a provider or other user may be provided an informational brochure (not shown) that has answers to common questions about the system and process, and to set expectations. Pre-assessment questions/tests can be stored in the memory of processing system 20. In embodiments of the invention, the pre-assessment questions/tests can include questions and/or tests relating to one or more of a user's demographics, practice area or specialty, practice needs, technology use history, resilience and/or other factors that may be useful for reliable comparison and trending analysis. During pre-assessment 32, the processing system 20 can access the memory and present all or some of the pre-assessment questions/tests to the user through the user interface 12. The user can respond and answer the questions/tests using the user interface 12, and processing system 20 can collect and evaluate the responses to the questions. In one embodiment, processing system 20 includes software from the REDCap Consortium to support the pre-assessment 32. Pre-assessment 32 is designed to take about 15-25 minutes of the user's time to complete in some embodiments of the invention.

Technical assessment 34 and clinical assessment 36 are components of a needs assessment. In some embodiments, the needs assessment is designed to take about 1½-2½ hours of the user's time to complete. A proctor can, but need not, monitor the user when completing the needs assessment. Tasks that can be provided by the proctor include: (1) helping with the technical functions of the computer system 10 and method 30, (2) recording observations regarding the navigational techniques and computer setup, (3) sending completed screen shots to clinical champions (EMR super-users) to verify accuracy, and (4) leading a struggling provider through the tasks (for example, a provider can be escorted to the next scenario if they've spent six times longer than best practice (e.g., as determined by previous participants)).

In connection with technical assessment 36, technical assessment questions/tests relating to an EMR user's technical capability to interact with computer interfaces can be stored in the memory of processing system 20. Examples of technical assessment questions/tests that can be used with the invention are those that assess keyboarding skills, learning style (e.g., using VARK), voice recognition capture rates, color blindness assessment and tablet metaphor testing. For example, a provider can be given a standardized script to dictate into a voice capture documentation tool. The “capture recognition rate” is the number of words correctly recorded by the tool. Tablet metaphor testing can make use of a series of navigational tasks that a provider performs on a mobile device such as a tablet (e.g., “open an App,” “group an App,” “access the mobile network,” and “print from the App to the mobile network”). The tasks can be scored as a plus/minus depending on whether the provider could or could not perform the task. During technical assessment 34, the processing system 20 can access the memory and present all or some of the technical assessment questions/tests to the user through the user interface 12. The user can respond and answer the questions/tests using the user interface 12, and processing system 20 can collect and evaluate the responses to the questions. In one embodiment, processing system 20 includes software from the REDCap Consortium to support the technical assessment 34.

In connection with the clinical assessment 36, practice specialty-specific clinical assessment scenarios (e.g., 24 scenarios in one embodiment) are stored in the memory of processing system 20. The clinical assessment scenarios are a series of tasks that are configured to be presented in a serial progression to simulate a typical work day. In embodiments, each of the clinical assessment scenarios has multiple EMR workflows. For example, the incorporation of electronic devices into an ambulatory provider's workday has resulted in a multitude of workflow changes. Tasks include how to find, open and enter a specific patient's chart, originate a prescription, modify a prescription, order a test, enter or modify a diagnoses/problem, notify a partner, activate a personal reminder, view and manipulate an x-ray image, graph a linear dataset, order multiple tests in a complex patient, navigate into an interfaced database, access clinical decision support tools, and perform in a downtime environment (e.g., use backup tools).

During the clinical assessment 36, the processing system 20 can access the memory and present a series of clinical assessment scenarios to the user through the user interface 12. The presented clinical assessment scenarios can be arranged in a manner that simulates a user's work day. The user responds and interacts with the scenarios using the user interface 12, and processing system 20 can collect and evaluate information relating to the user's responses and interactions. For example, in embodiments, the user can start a clinical assessment scenario by actuating a start button. After the scenario is started, the processing system 20 can begin a timer to determine the length of time the user takes to complete the scenario. Additionally or alternatively, the processing system 20 can count and/or time keystrokes and mouse clicks and record screens used by the user during the scenario. “Test” patients can be presented to the user for purposes of completing the presented scenario encounters. Alternatively, the “test” patients can be recordings stored in the memory of processing system 20 or other video system, and presented to the user. The value of the assessment can be enhanced by presenting scenarios that closely approximate or simulate events during an actual clinic day.

As part of the clinical assessment 36, the processing system 20 can also present to the user certain scenario background questions relating to the clinical assessment scenarios, and prompt the user to respond to those questions. Examples of the types of background questions that can be presented are how frequently the user performs the scenario and the value of the scenario to the user's practice. These questions, which can be stored in the memory of the processing system 20, can be presented before and after the associated clinical assessment scenario. The user interface 12 can be used to present the scenario background questions and to receive the user's responses.

Method 30 can also make use of scenario value assessments provided by the organization to which the user belongs (e.g., the clinic employing the user). The organization value can, for example, be entered into the computer system 10 through the user interface 12 by an administrator in connection with the performance of the method by a user, and/or stored in memory of the processing system 20.

The user's responses to the clinical assessment scenarios are collected and evaluated by the processing system 20. In one embodiment, for example, the responses to the clinical assessment scenarios can be measured by Morae software which is a separate enveloping program overlying and measuring the EMR functions. The Morae measurements can be automatically uploaded into an Access or other database that combines and organizes the data collected during the pre-assessment 32, technical assessment 34 and clinical assessment 36. An assessment of the user's efficiency (or inefficiency) can, for example be determined.

In embodiments, the method 30 uses and/or calculates numerical values representative of parameters such as the user's inefficiency, personal frequency of performing a scenario, personal value of the scenario and the organizations value of the scenario during analysis and report generation step 40. Quantitative or numerical values characterizing the user's capabilities or needs with respect to each of the scenarios can be calculated. In one embodiment for example, method 30 generates a prioritized learning assessment of need number (PLAN) using the following formula:

PLAN=Inefficiency×(0.075×(Personal Frequency+Personal Value))+Organization Value

Other computational methodologies can be used in other embodiments of the invention. The PLAN or other quantitative assessments can be prioritized in numerical order, and can be used to generate a personal comparison report relative to matched peers for both individual scenarios and total EMR proficiency. Patient satisfaction scores, provider productivity scores (e.g., Medical Group Management Association scores) and other measures can be included in the database in processing system 20 and included in the computed output measures and reports. Other and additional reports can also be generated during the analysis and report generation step 38. A user's performance can be graded in efficiency and accuracy against provider-participants peers. The needs and capability assessments can also be compared to best practice benchmarks. The calculations also give a number for each scenario allowing for prioritizing a list of educational points and objectives for the provider.

The quantified needs or capability assessment can be used in connection with the expertise development materials selection 40. For example, the priority associated with the PLAN or other assessment can be used by the processing system 20 to identify the scenarios for which the user might benefit from additional training. Information derived from the technical assessment 34 can also be used to identify which of several development materials might be best suited for a user. For example, a given scenario might have audio and graphical expertise development materials, and the processing system 20 can identify which of those development materials sets would be recommended to the user based on the technical assessment 34. This information can be presented on the user interface 12. In still other embodiments the development materials are stored in the memory of the processing system 20, and can be presented to the user through the user interface 12. The provider can thereby be given a prioritized personal improvement plan.

The user can be instructed on the best way to quickly, completely and safely complete a particular scenario. System 10 and method 30 thereby provide measurements that can prove to providers with diminished competency why certain workflows are desirable. There may be several approaches to training (e.g., mentorship, shepherding, classroom, quick sheets and videos). Utilizing the personal learning style from the technical assessment 34 and future assessments, the best training materials can be developed. Bias can be accounted for by combining the technical/demographic variables in the complete program allowing for accurately matched cohorts. This allows upgrades and training descriptions to become a scientific and analytical event rather than relatively imprecise and subjective events.

Computer system 10 and method 30 can be configured for use with ambulatory clinic providers and other providers in other settings (e.g., inpatient, nursing, ER, surgical and pharmacy). The end user groups can determine the important workflows and tasks, demographic and technical variables. They provide an evidence-based approach for resolving dysfunction associated with the use of EMR, as well as enhancing the ability to provide high-quality patient care using automated tools. This data can be used to achieve the following: (1) develop a personal and prioritized improvement plan, (2) allow for objective comparisons to inspire personal change, (3) identify and share best practices, (4) validate users and departments in EMR proficiency, (5) compare suggested upgrades and changes to specific environments and practices using objective measurements to give identified impact reports, training points and prediction on learning times before any go live, (6) give data and guidance to the EMR optimization efforts using the consolidated results, (7) produce predictive trends that can prevent practice, EMR and training problems before they occur, and (8) cross compare efficiencies between EMR vendors and to clarify industry standards.

Although the present invention is described with reference to preferred embodiments, those skilled in the art will recognize that changes can be made in form and detail without departing from the spirit and scope of the invention.

What is claimed is:

1. A method for operating a computer system to assess a user's ability to use an electronic medical record (EMR) system, comprising:
presenting, on a user interface, clinical assessment scenarios and prompting the user's responses to the scenarios, wherein the scenarios simulate a work day and each scenario has multiple EMR workflows;
receiving through the user interface and evaluating the user's responses to the clinical assessment scenarios, wherein evaluating the responses includes one or more of determining a length of time to complete the scenario, counting keystrokes/clicks to complete the scenario and recording the screens viewed during the scenario;
presenting, on a user interface, scenario background questions relating to the clinical assessment scenarios, and prompting the user's responses to the scenario background questions, wherein the scenario background questions assess one or more of how frequently the user performs the scenario and the value of the scenario to the user's practice;
receiving through the user interface and evaluating the user's responses to the scenario background questions; and
generating a quantitative assessment of need for the clinical assessment scenarios based on the evaluated clinical assessment scenario responses and the scenario background question responses.

2. The method of claim 1 wherein generating the quantitative assessments of need for the clinical assessment scenarios further includes generating the quantitative assessments based on values of the scenarios to an organization to which the user belongs.

3. The method of claim 2 wherein:
evaluating the user's responses to the clinical assessment scenarios includes generating a quantitative assessment representative of the user's inefficiency; and
generating the quantitative assessments of need for the clinical assessment scenarios includes generating the quantitative assessments of need based on the quantitative assessment of the user's inefficiency.

4. The method of claim 3 wherein generating the quantitative assessments of need includes generating the quantitative assessments based on both of how frequently the user performs the scenario and the value of the scenario to the user's practice.

5. The method of claim 4 and further including generating a prioritized list of scenario assessments of need based on the quantitative assessments for the scenarios.

6. The method of claim 4 and further including identifying expertise development materials based on the quantitative assessments of need for the scenarios.

7. The method of claim 6 and further including:
presenting, on a user interface, technical assessment questions/tests relating to an EMR user's technical capability to interact with computer interfaces, and prompting the user's responses to the questions/tests, wherein the technical assessment questions/tests include questions/tests to assess one or more of keyboarding skills, learning style, voice recognition capture rates, color blindness and tablet metaphor skills;
receiving through a user interface and evaluating the user's responses to the technical assessment questions/tests; and
wherein identifying the expertise development materials includes identifying the development materials based on the user's responses to the technical assessment questions/tests.

8. The method of claim 4 and further including:
presenting, on a user interface, pre-assessment questions/tests relating to EMR skills, wherein the pre-assessment questions/tests include questions/tests relating to one or more of the user's demographics, practice area, needs, technology use history and resilience;
receiving through the user interface and evaluating the user's responses to the pre-assessment questions/tests; and
generating reports based on the user's responses to the pre-assessment questions/tests.

9. The method of claim 4 wherein presenting clinical assessment scenarios includes presenting scenarios including one or more of (1) finding, opening and entering a patient's chart, (2) originating a prescription, (3) modifying a prescription, (4) ordering a test, (5) entering or modifying a diagnosis/problem, (6) notifying a partner, (7) activating a personal reminder, (8) viewing and manipulating an x-ray image, (9) graphing a dataset, (10) ordering multiple tests in a complex patient, (11) navigating into an interfaced database, and (12) accessing clinical decision support tools.

10. A computer system configured to assess a user's ability to use an electronic medical record (EMR) system, comprising:
a database including:
a plurality of clinical assessment scenarios, wherein the scenarios simulate a work day and each scenario has multiple EMR workflows; and
scenario background questions relating to the clinical assessment scenarios, wherein the background questions assess one or more of how frequently the user performs the scenario and the value of the scenario to the user's practice;
a user interface; and
a processing system coupled to the database and user interface and configured to:
access the database and present, on the user interface, the clinical assessment scenarios, and prompt the user's response to the clinical assessment scenarios;
access the database and present, on the user interface, the scenario background questions, and prompt the user's responses to the scenario background questions;
receive from the user interface and evaluate the user's responses to the clinical assessment scenarios, including one or more of determining a length of time to complete the scenario, counting keystrokes/clicks to complete the scenario and recording the screens viewed during the scenario;
receive from the user interface and evaluate the user's responses to the scenario background questions; and
generate a quantitative assessment of need for the clinical assessment scenarios based on the evaluated clinical assessment scenario responses and the scenario background question responses.

11. The computer system of claim 10 wherein the processing system is configured to generate the quantitative assessments of need based on values of the scenarios to an organization to which the user belongs.

12. The computer system of claim 11 wherein the processing system is configured to:
generate a quantitative assessment representative of the user's inefficiency; and
generate the quantitative assessments of need based on the quantitative assessment of the user's inefficiency.

13. The computer system of claim 12 wherein the processing system generates the quantitative assessments of need based on both of how frequently the user performs the scenario and the value of the scenario to the user's practice.

14. The computer system of claim 13 wherein the processor generates a prioritized list of scenario assessments of need based on the quantitative assessments for the scenarios.

15. The computer system of claim 13 wherein:
the database includes expertise development materials; and
the processing system identifies expertise development materials based on the quantitative assessments for the scenarios.

16. The computer system of claim 15 wherein:
the database includes technical assessment questions/tests relating to an EMR user's technical capability to interact with computer interfaces, including questions/tests to assess one or more of keyboarding skills, learning style, voice recognition capture rates, color blindness and tablet metaphor skills; and
the processing system is configured to:
access the database and present, on the user interface, the technical assessment questions/tests, and prompt the user's responses to the technical assessment questions/tests;
receive from the user interface and evaluate the user's responses to the technical assessment questions/tests; and
identify expertise development materials based on the user's responses to the technical assessment questions/tests.

17. The computer system of claim 13 wherein:
the database includes pre-assessment questions/tests relating to EMR skills, wherein the pre-assessment questions/tests include questions/tests relating to one or more of user's demographics, practice area, needs, technology use history and resilience; and
the processing system is configured to:
access the database and present, on the user interface, the pre-assessment questions/tests, and prompt the user's responses to the pre-assessment questions/tests;
receive through the interface and evaluate the user's responses to the pre-assessment questions/tests; and
generate reports based on the user's responses to the pre-assessment questions/tests.

18. The computer system of claim 13 wherein the database includes clinical assessment scenarios including one or more of (1) finding, opening and entering a patient's chart, (2) originating a prescription, (3) modifying a prescription, (4) ordering a test, (5) entering or modifying a diagnosis/problem, (6) notifying a partner, (7) activating a personal reminder, (8) viewing and manipulating an x-ray image, (9) graphing a dataset, (10) ordering multiple tests in a complex patient, (11) navigating into an interfaced database, and (12) accessing clinical decision support tools.
